(19) United States
(12) Patent Application Publication
(10) Pub. No.: US 2002/0183033 A1
(43) Pub. Date: Dec. 5, 2002

(54) Commutating image-reject mixer

(75) Inventors: Gong Gu, Bridgewater, NJ (US); Robert Conrad Malkemes, Bricktown, NJ (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(73) Assignee: Sarnoff Corporation

(21) Appl. No.: 09/826,974

(22) Filed: Apr. 5, 2001

(51) Int. Cl. H04B 1/10; H04B 1/26

(52) U.S. Cl. 455/302; 455/326

(57) ABSTRACT

A commutating image-reject mixer includes first and second branches, each having first and second stage mixers for converting the frequency of a desired channel to an intermediate frequency (IF) and rejecting the image channel. The local oscillator (LO) ports of all the mixers are commutated between quadrature and in-phase LO signals, and the output of the branches are commutated between each other, by two complementary, 50% duty cycle clock signals. The commutating image-reject mixer exhibits improved immunity to amplitude and phase mismatches that may be present in each branch.

### BACKGROUND OF THE INVENTION

1. Field of the Invention

The invention generally relates to image-reject mixers and, more particularly, the invention relates to an image-reject mixer using local oscillator signals with commutating phases.

2. Description of the Related Art

In general, radio frequency (RF) receivers employ mixers for converting high frequency RF signals to lower frequency signals, which are usually called intermediate frequency (IF) signals. Conversion to IF allows the receiver to more easily process the signals, for instance, during amplification. A typical mixer circuit mixes the incoming RF signal of frequency ω_{RF} with a local oscillator (LO) signal of a different frequency ω_{LO}. The output of the mixer will then contain a frequency component equal to the magnitude of the difference between the RF signal and the LO signal frequencies, that is, |ω_{RF}−ω_{LO}|. That output signal at that frequency component is the IF signal. It is clear, from the above, that ω_{RF} may be above or below ω_{LO} by an amount that is equal to the IF. In other words, for a given LO signal, the mixer circuit derives an IF signal from either of two incoming RF frequencies of particular interest: that of the desired RF signal and that of its image.

Thus, RF receivers require image-reject mixers to properly demodulate the desired RF signal while rejecting the image signal. In some instances, such as in dual-band RF receivers where the two bands are images of each other, image-reject mixers are required to independently demodulate each band without interference between the two bands.

FIG. 1 depicts a block diagram of a Weaver image-reject mixer 100 as is known in the art. The Weaver image-reject mixer 100 comprises an in-phase (I) mixing branch 102I and a quadrature (Q) mixing branch 102Q. Each branch 102 comprises first and second stage mixers 104 and 106, first and second stage LOs 108 and 110, and first stage filters 112. LOs 108I and 110I generate in-phase LO signals for mixers 104I and 106I, respectively. LOs 108Q and 110Q generate quadrature LO signals for to mixers 104Q and 106Q, respectively. Branches 102I and 102Q are coupled to a combiner 114, which in turn is coupled to a second stage filter 116.

Incoming RF signals of frequencies ω_{RF} and ωᵢₘ are coupled to each branch 102I and 102Q. First stage mixers 104 convert the frequency of the incoming signals to a first IF frequency. Second stage mixers 106 convert the frequency of the first IF signals to a second IF frequency. If the frequency of the desired incoming signal is ω_{RF}, a minus is taken for the quadrature branch 102Q at the combiner 114. Conversely, if the frequency of the desired Incoming signal is ωᵢₘ, a plus is taken for the quadrature branch 102Q at the combiner 114.

In either case, the combiner 114 combines the second IF signals, which results in the cancellation of the image signal component and the summation of the desired signal component. The image rejection ratio (IRR), defined as the ratio of the IF signal power resulting from the image to that originated from the desired component, is:

$$IRR = \frac{{( Δ A )}^{2} + {( Δθ )}^{2}}{4} , \qquad \text{Eq. 1}$$

where ΔA and Δθ are the amplitude gain and phase mismatches of the two branches, respectively. Ideally, if both amplitude and phase mismatches are zero, then IRR=0 (i.e., complete image rejection is obtained). Current image-reject mixers, such as the Weaver image-reject mixer, are susceptible to such mismatches, especially when off-chip, discrete components are used, which causes incomplete image rejection.

Therefore, there exists a need in the art for an image-reject mixer capable of complete image rejection in the presence of amplitude and phase mismatches.

### SUMMARY OF THE INVENTION

The disadvantages associated with the prior art are overcome by a commutating image-reject mixer comprising a first mixing branch and a second mixing branch. Incoming radio frequency (RF) signals having both upper and lower band components that are images of each other are coupled to each mixing branch. Each mixing branch comprises a first stage mixer and filter and a second stage mixer and filter. The phases of the local oscillator (LO) signals of the first and second stage mixers are commutated between 0 degrees and 90 degrees at a 50% duty cycle. In addition, the outputs of the branches are commutated between each other in the same manner as the LO phases are commutated. The two branches are coupled to a combiner, which cancels the image component and combines the desired component.

In an alternative embodiment, the commutating image-reject mixer comprises a single mixing branch. The single mixing branch comprises a first stage mixer and filter and a second stage mixer and filter. The phases of the local oscillator (LO) signals of the first and second stage mixers are commutated between 0 degrees and 90 degrees at a 50% duty cycle. The output of the second stage filter is modulated by the commutation frequency, which cancels the image component and passes the desired component.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a block diagram of a Weaver image-reject mixer as is known in the art;

FIG. 2 depicts a block diagram of a radio frequency (RF) receiver having a commutating image-reject mixer of the present invention;

FIG. 3 depicts a block diagram of one embodiment of a commutating image-reject mixer;

FIG. 4A graphically depicts the derivation of first and second intermediate frequencies by the commutating image-reject mixer of FIG. 3;

FIG. 4B shows exemplary commutation clock waveforms;

FIG. 5 graphically illustrates of the signal spectra after first stage mixing;

FIG. 6A depicts a graph of the residual image signal after second stage mixing in a conventional Weaver image-reject mixer;

FIG. 6B depicts a graph of the residual image signal after second stage mixing in the commutating image-reject mixer of the present invention; and

FIG. 7 depicts a block diagram of one embodiment of a commutating image-reject mixer having one branch.

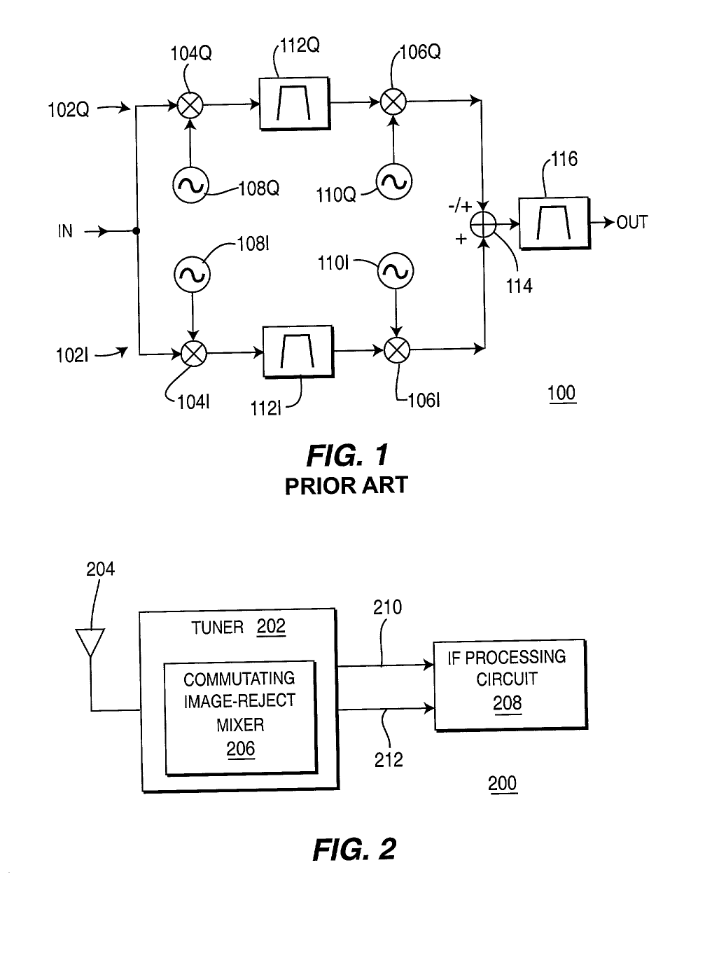

### DETAILED DESCRIPTION OF THE PREFERRED EMBODIMENT

FIG. 2 depicts a radio frequency (RF) receiver 200. The RF receiver comprises an antenna 204, a tuner 202 having a commutating image-reject mixer 206, and an intermediate frequency (IF) processing circuit 208. The antenna 204 receives RF signals in a frequency band, specifically, an RF signal having a frequency ω_{RF} (hereinafter the upper band signal) and an RF signal having a frequency ωᵢₘ (hereinafter the lower band signal). The upper and lower band signals are images of each other. In dual band receivers, it is generally desirable to receive both of the signals. The antenna 204 couples the received signals to the tuner 202. The tuner 202 uses the commutating image-reject mixer 206 to derive IF signals from both the upper and lower band signals. When processing one of the upper and lower band signals, the commutating image-reject mixer 206 rejects the other image signal. In this manner, both the upper and lower band signals are received without image signal interference. The upper and lower band signals are then coupled to the IF processing circuit 208 via signal paths 210 and 212, respectively. Although the RF receiver 100 has been described as a dual band receiver, those skilled in the art understand that the commutating image-reject mixer 206 can be used with single band RF receivers as well. In that case, the commutating image-reject mixer 206 would select only one of the bands, while the other band would be rejected.

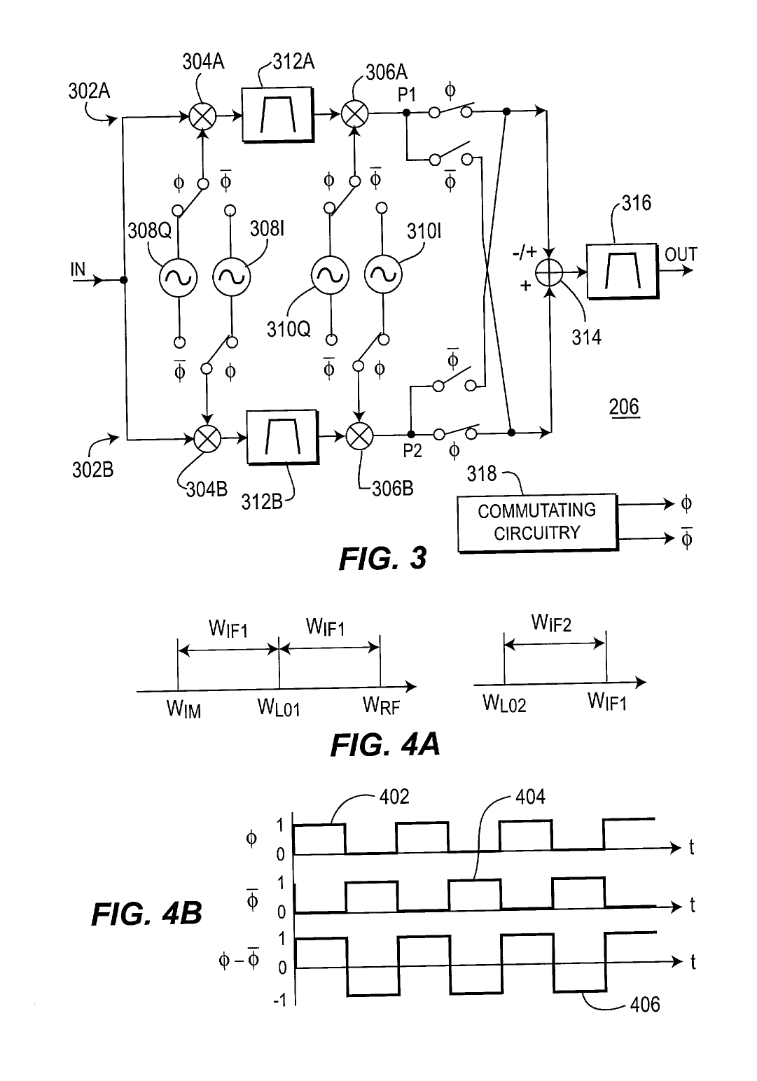

FIG. 3 depicts a block diagram of one embodiment of the commutating image-reject mixer 206. In the present embodiment, the commutating image-reject mixer 206 comprises a first mixing branch 302A, a second mixing branch 302B, in-phase local oscillators (LOs) 308I and 310I, quadrature LOs 308Q and 310Q, and commutating circuitry 318. Mixing branch 302A comprises first and second stage mixers 304A and 306A, and a first stage filter 312A. Likewise, mixing branch 302B comprises first and second stage mixers 304B and 306B, and a first stage filter 312B. First stage filters 312A and 312B are bandpass or lowpass filters that have identical center or cut-off frequencies, respectively. Branches 302A and 302B are coupled to a combiner 314, which in turn is coupled to a second stage filter 316. The second stage filter 316 is a band-pass or low-pass filter as required. In an alternative embodiment, second stage filter 316 comprises two identical filters that are disposed between second stage mixers 306A and 306B and the combiner 314, respectively.

The commutating circuitry 318 generates two complementary, 50% duty cycle clock signals φ and \overline{φ}.The commutating circuitry 318 commutates the LO inputs of first stage mixers 304A and 304B between LOs 308Q and 308I by the two clocks φ and \overline{φ}. The commutation is in a complementary fashion, that is, when mixer 304A is coupled to LO 308Q, mixer 304B is coupled to LO 308I. Likewise, the commutating circuitry 318 commutates the LO inputs of second stage mixers 306A and 306B between LOs 310Q and 310I in a complementary fashion by the clocks φ and \overline{φ}. Thus, when clock φ is in the high state, branch 302A is receiving quadrature LO signals and branch 302B is receiving in-phase LO signals. Conversely, when clock \overline{φ} is in the high state, branch 302B is receiving quadrature LO signals and branch 302A is receiving in-phase LO signals.

FIG. 4B illustrates exemplary waveforms for the clock signals. Clock φ is a 50% duty cycle square wave 402 that oscillates between logical 0 and logical 1 at a predetermined frequency. Clock \overline{φ} is a square wave 404 that is complementary to square wave 402. The difference between clocks φ and \overline{φ} is shown by square wave 406, which oscillates between logical −1 and logical 1 at the predetermined frequency.

Returning to FIG. 3, after second stage mixers 306A and 306B, the commutating circuitry 318 also commutates branches 302A and 302B between each other by clocks φ and \overline{φ}. In an alternative embodiment, the branches 302A and 302B are not commutated, but rather the output of the combiner 314 is modulated by the commutation frequency (i.e., the frequency of φ-\overline{φ}). Modulating the output of the combiner 314 by the commutation frequency is equivalent to commutating the outputs of the two branches 302A and 302B with each other. In any case, the commutating image-reject mixer 206 averages out any mismatches present in the two branches 302A and 302B over an extended period of time.

In operation, the upper and lower band signals are coupled to each branch 302A and 302B. First stage mixers 304A and 304B convert the frequency of the incoming signals to a first IF and then second stage mixers 306A and 306B convert the frequency of the first IF signals to a second IF. First stage filters 312A and 312B are centered at the first IF, while second stage filter 316 is centered at the second IF. The filters 312A, 312B, and 316 remove high-frequency components generated by the mixing process. The frequencies of the IF signals depend on the application, which includes having the second IF be zero (i.e., baseband). If a minus is taken for the branch 302A at the combiner 314, that is, the combiner 314 is a subtractor, then the image-reject mixer 206 derives an IF signal from the upper band signal and rejects the lower band signal (i.e., the image signal). Conversely, if a plus is taken for the branch 302A at the combiner 314, that is, the combiner 314 is an adder, then the image-reject mixer 206 derives an IF signal from the lower band signal and rejects the upper band signal.

FIG. 4A graphically depicts the relation in frequency between the incoming upper and lower band signals, the LO signals, and the IF signals. As shown, the frequency of the upper band signal (ω_{RF}) is above the frequency of the first stage LOs 308Q and 308I (ω_{LO1}) Thus, if the image-reject mixer 206 derives an IF signal from the upper band, the first stage mixers 304A and 304B use low-side injection. The frequency of the lower band signal (ωᵢₘ) is lower than the frequency of the first stage LOs, which requires the first stage mixers 304A and 304B to use high-side injection to recover the lower band signal.

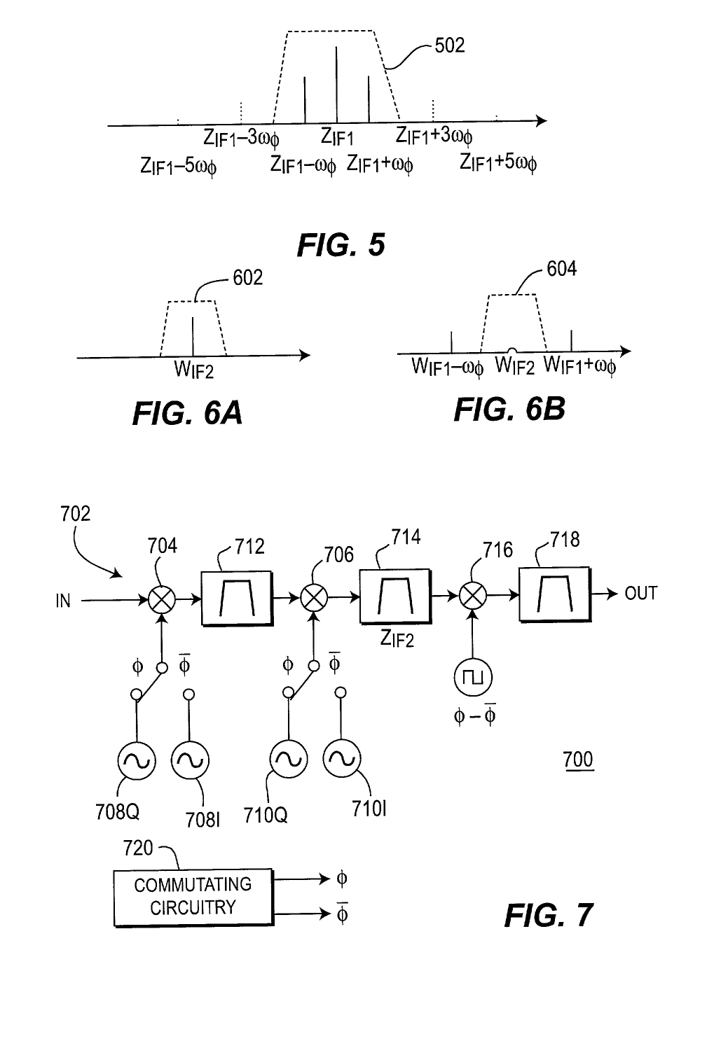

More specifically, the signals at the output of the first stage mixers 304A and 304B contain the following frequencies: ω_{IF1} and ω_{IF1} ±nω_{φ}), where ω_{IF1} is the frequency of the first IF, ω_{φ}is the frequency of the clocks φ and \overline{φ}, and n are odd integers, the maximum of which is determined by the pass band of the first stage filters 312A and 312B. FIG. 5 graphically illustrates the signal spectra after first stage mixers 304A and 304B. As shown, the pass band 502 of first stage filters 312A and 312B contains only ω_{IF1} and ω_{IF1}±ω_{φ}(i.e., n=1). All other frequencies are rejected.

Returning to FIG. 3, if a minus is taken for the branch 302A as described above (low-side injection), then in regards to the upper band signal, the spectra of the signal at the output of the second stage mixer 306A (designated point P1 in FIG. 3) is:

$$P1 = ( \frac{π}{8} - \frac{1}{π} ) δ ( ω + {ω}_{IF2} ) + ( \frac{π}{8} - \frac{1}{π} ) δ ( ω - {ω}_{IF2} ) + \frac{1}{2} δ [ ω + ( {ω}_{IF2} + {ω}_{φ} ) ] + \frac{1}{2} δ [ ω - ( {ω}_{IF2} + {ω}_{φ} ) ] - \frac{1}{2} δ [ ω + ( {ω}_{IF2} - {ω}_{φ} ) ] - \frac{1}{2} δ [ ω - ( {ω}_{IF2} - {ω}_{φ} ) ] , \qquad \text{Eq. 2}$$

where ω_{IF2} is the frequency of the second IF and where all high frequencies filtered by the second stage filter 316 are ignored. Likewise, the spectra of the upper band signal at the output of the second stage mixer 306B (designated point P2 in FIG. 3) is:

$$P2 = ( \frac{π}{8} - \frac{1}{π} ) δ ( ω + {ω}_{IF2} ) + ( \frac{π}{8} - \frac{1}{π} ) δ ( ω - {ω}_{IF2} ) - \frac{1}{2} δ [ ω + ( {ω}_{IF2} + {ω}_{φ} ) ] - \frac{1}{2} δ [ ω - ( {ω}_{IF2} + {ω}_{φ} ) ] + \frac{1}{2} δ [ ω + ( {ω}_{IF2} - {ω}_{φ} ) ] + \frac{1}{2} δ [ ω - ( {ω}_{IF2} - {ω}_{φ} ) ] , \qquad \text{Eq. 3}$$

again where all high frequencies filtered out by second stage filter 314 are ignored. Hence, the difference between the signals at the output of second stage mixers 306B and 306A is:

P2−P1=−δ[ω+(ω_{IF2}+ω_{φ})]−δ[ω−(ω_{IF2}+ω_{φ})]+δ[ω+(ω_{IF2}−ω_{φ})]+δ[ω−(ω_{IF2}−ω_{φ})] Eq. 4,

which contains only ω_{IF2}±ω_{φ} and no ω_{IF2} components.

As described above, the commutation between the branches 302A and 302B after the second stage mixers 306A and 306B is equivalent to modulating their difference by (φ−\overline{φ}). The output of the combiner 314 is thus the convolution of the spectra of (P2−P1) and (φ−\overline{φ}), or:

$$\frac{1}{2 π} ( P2 - P1 ) * F [ φ - \overline{φ} ] . \qquad \text{Eq. 5}$$

The output of second stage filter 316 can be expressed by the equation:

$$OUTPUT\_IF = \frac{4}{π} j [ δ ( ω + {ω}_{IF2} ) - δ ( ω - {ω}_{IF2} ) ] . \qquad \text{Eq. 6}$$

Thus, the image-reject mixer 206 converts the upper band signal to an IF signal having a frequency of the second IF.

As for the lower band signal (i.e., the image signal in the low-side injection case), the spectra at points P1 and P2 are:

$$P1 = P2 = - ( \frac{π}{8} + \frac{1}{π} ) j δ ( ω + {ω}_{IF2} ) + ( \frac{π}{8} + \frac{1}{π} ) j δ ( ω - {ω}_{IF2} ) . \qquad \text{Eq. 7}$$

In the case where each of the branches 302A and 302B possess no mismatches, the image signal is completely rejected (i.e., P2−P1=0). In the case of mismatches, however, the two branches 302A and 302B have different respective gains G_{A}(ω) and G_{B}(ω), where G_{A} and G_{B} are complex, containing both amplitude and phase mismatches. For the image signal, the output of the combiner 314 given mismatches is:

$$\frac{1}{2 π} ( {G}_{B} P2 - {G}_{A} P1 ) * F [ φ - \overline{φ} ] = \frac{1}{2 π} ( {G}_{B} - {G}_{A} ) P2 * F [ φ - \overline{φ} ] , \qquad \text{Eq. 8}$$

which contains frequencies ω_{IF2}±ω_{φ} and no ω_{IF2} components. The second stage filter 316 has a pass-band that is less than 2ω_{φ}, resulting in the output having no image component (i.e., complete image cancellation is achieved).

This result is shown graphically in FIG. 6. FIG. 6 shows the residual image signal after second stage mixing (before the combiner 314) in both the prior art Weaver image-reject mixer and the commutating image-reject mixer of the present invention. FIG. 6A shows the pass-band 602 of the second stage filter 116 in the Weaver image-reject mixer. The uncanceled image signal having a frequency of the second IF is present at the output of the second stage mixers 106. Thus, if the combiner 114 does not completely cancel the image components (i.e., there are mismatches in the branches 102), the residual image signal appears within the pass band 602 of the second stage filter 116, and thus interferes with the desired signal. FIG. 6B shows the pass-band 604 of the second stage filter 316 in the commutating image-reject mixer of the present invention. The residual image signals are pushed out of the pass-band 604 of the second stage filter 316. Therefore, even in the presence of mismatches that cause incomplete image cancellation after the combiner 314, the image signal is suppressed by the second stage filter 316.

Returning to FIG. 3, if a plus is taken for the branch 302A (i.e., high-side injection), then the commutating image-reject mixer 206 will select the lower band signal and will reject the upper band signal. Regarding the lower band signal, the output of the second stage filter 316 is:

$$OUTPUT\_im = P1 + P2 = - ( \frac{π}{4} + \frac{2}{π} ) j δ ( ω + {ω}_{IF2} ) + ( \frac{π}{4} - \frac{2}{π} ) j δ ( ω - {ω}_{IF2} ) . \qquad \text{Eq. 9}$$

For the upper band signal (i.e., the image signal in the high-side injection case), the output of the second stage filter 316 is:

$$OUTPUT\_RF = P1 + P2 = ( \frac{π}{4} - \frac{2}{π} ) j δ ( ω + {ω}_{IF2} ) + ( \frac{π}{4} - \frac{2}{π} ) j δ ( ω - {ω}_{IF2} ) , \qquad \text{Eq. 10}$$

which indicates incomplete image rejection. This result is due to the limited bandwidth of the first stage filters 312A and 312B. For narrow band signals, the first stage filters 312A and 312B can be designed to pass a sufficient number of harmonics (i.e., n>1) in order to approach complete image rejection.

Although the various embodiments of the present invention have been described as selecting either the upper or the lower band signal while rejecting the image, those skilled in the art understand that the image-reject mixer 206 can be adapted to select both the upper band and the lower band while rejecting the image for each band. In such an embodiment, the combiner 314 comprises a subtractor for selecting the upper band signal and an adder for selecting the lower band signal. In addition, those skilled in the art understand that instead of the LOs being commutated between the mixers, the commutating circuitry 318 could commutate the first stage mixers 304A and 304B and the second stage mixers 306A and 306B between each other, respectively, in which case they would have fixed LO inputs. In such an embodiment, the commutating circuitry 318 could also commutate the first stage filters 312A and 312B between each other for symmetry.

Since the commutating image-reject mixer 206 shown in FIG. 3 is immune to any mismatches in the branches 302A and 302B, the gain of one of the branches can be zero, which means an image-reject mixer 206 may use only one branch. FIG. 7 depicts a block diagram of one embodiment of a commutating image-reject mixer 700 having only one mixing branch 702. In the present embodiment, the commutating image-reject mixer 700 comprises first and second stage mixers 704 and 706, first stage LOs 708I and 708Q, second stage LOs 710I and 710Q, first and second stage filters 712 and 714, a commutating mixer 716, a third stage filter 718, and commutating circuitry 720. The commutating circuitry 720 commutates the LO input of the first stage mixer 704 between LOs 708I and 708Q by two complementary 50% duty cycle clocks φ and \overline{φ}. Likewise, the commutating circuitry 720 commutates the LO input of the second stage mixer 706 between LOs 710I and 71OQ by the clocks φ and \overline{φ}.

The output of the second stage filter 714 is coupled to the commutating mixer 716. The commutating mixer 716 is added to modulate the output of the second stage filter 714 by the commutation frequency. The third stage filter 718 has a pass-band centered at the second IF and rejects high frequency components generated by the mixing process. The output of the third stage filter is an IF signal derived from the upper band signal (i.e., low-side injection case). If the lower band signal is desired, the output of the second stage filter 714 should be used. Thus the single branch image-reject mixer 700 can be used to derive IF signals for both the upper and lower band signals simultaneously.

Although the various embodiments of commutating image-reject mixers described in detail herein were described using 50% duty cycle square waves as commutation clocks φ and \overline{φ}, those skilled in the art could readily devise alternative 50% duty cycle clock signals. In one embodiment, a commutating image reject mixer, such as one described in FIGS. 3 or 7, employs two complementary pseudo-random digital signals with a central frequency larger than the bandwidth of the two bands. In the general case, the commutation clocks may be any waveform containing DC and odd harmonics of ω_{φ}, that is:

$$\begin{matrix}φ = 1 + {\sum }_{n} {C}_{n} {sin}^{2} ( \frac{n π}{2} ) sin {ω}_{φ} t \\ \overline{φ} = 1 - {\sum }_{n} {C}_{n} {sin}^{2} ( \frac{n π}{2} ) sin {ω}_{φ} t ,\end{matrix} \qquad Eq . 11$$

where 0≦φ≦1 and 0≦\overline{φ}≦1.

In addition, the LO signals used in the various embodiments described herein can be expressed as follows:

φ(t)I(t)+\overline{φ}(t)Q(t)

or

\overline{φ}(t)I(t)+φ(t)Q(t) Eq. 12,

where I(t) and Q(t) are in-phase and quadrature LO signals, respectively. Alternatively, the LO signals can be directly generated, dispensing with the need to commutate the LO inputs to the mixers. In such an embodiment, the commutating circuitry 318 and 720 would directly generate LO signals that are commutated between in-phase and quadrature phases.

While foregoing is directed to the preferred embodiment of the present invention, other and further embodiments of the invention may be devised without departing from the basic scope thereof, and the scope thereof is determined by the claims that follow.

1. An image-reject mixer comprising:
a first mixing branch having a first plurality of mixers, each of said first plurality of mixers having a local oscillator (LO) input;
a second mixing branch having a second plurality mixers, each of said second plurality of mixers having a LO input;
a combiner for generating an intermediate frequency (IF) signal from the outputs of said first and second mixing branches; and
commutating circuitry for commutating said LO inputs of each of said first plurality of mixers and each of said second plurality of mixers between in-phase and quadrature phases, and for commutating the outputs of said first and second mixing branches between each other.

2. The image-reject mixer of claim 1 wherein said commutating circuitry generates two complementary 50% duty cycle clock signals for commutating said LO inputs of each of said first plurality of mixers and each of said second plurality of mixers between in-phase and quadrature phases, and for commutating said first and second branches between each other.

3. The image-reject mixer of claim 2 wherein said clock signals are waveforms selected from the group consisting of square waves and pseudo-random digital signals.

4. The image-reject mixer of claim 2 wherein said commutating circuitry commutates the outputs of said first and second mixing branches between each other by modulating the output of said combiner by the difference between said clock signals.

5. The image-reject mixer of claim 1 wherein said commutating circuitry couples a LO signal that is commutated between in-phase and quadrature phase to said LO inputs of each of said first plurality of mixers and each of said second plurality of mixers.

6. The image-reject mixer of claim 1 wherein said combiner comprises an adder and a subtractor for generating two IF signals corresponding to two RF signals that are images of each other.

7. An image-reject mixer comprising:
a first mixing branch having a first plurality of mixers;
a second mixing branch having a second plurality mixers;
a combiner for generating an intermediate frequency (IF) signal from the outputs of said first and second mixing branches; and
commutating circuitry for commutating each of said first plurality of mixers and each of said second plurality of mixers between each other, and for commutating the outputs of said first and second branches between each other.

8. The image-reject mixer of claim 7 wherein said commutating circuitry generates two complementary 50% duty cycle clock signals for commutating said LO inputs of each of said first plurality of mixers and each of said second plurality of mixers between each other, and for commutating said first and second branches between each other.

9. The image-reject mixer of claim 8 wherein said clock signals are waveforms selected from the group consisting of square waves and pseudo-random digital signals.

10. The image-reject mixer of claim 8 wherein said commutating circuitry commutates the outputs of said first and second mixing branches between each other by modulating the output of said combiner by the difference between said clock signals.

11. The image-reject mixer of claim 7 wherein said combiner comprises an adder and a subtractor for generating two IF signals corresponding to two RF signals that are images of each other.

12. An image-reject mixer comprising
a first mixer having a first filter and a local oscillator (LO) input;
a second mixer having a second filter and a LO input; and
commutating circuitry for commutating said LO inputs of said first mixer and said second mixer between in-phase and quadrature phases.

13. The image-reject mixer of claim 12 wherein said commutating circuitry generates two complementary 50% duty cycle clock signals for commutating said LO inputs of said first mixer and said second mixer between in-phase and quadrature phases.

14. The image-reject mixer of claim 13 wherein said clock signals are waveforms selected from the group consisting of square waves and pseudo-random digital signals.

15. The image-reject mixer of claim 12 wherein said commutating circuitry couples a LO signal that is commutated between in-phase and quadrature phases to said LO inputs of said first mixer and said second mixer.

16. The image-reject mixer of claim 12 further comprising a commutating mixer for modulating the output of said second filter by the difference between said complementary clock signals, said commutating mixer having a third filter.

17. A method of rejecting an image signal comprising:
mixing a radio frequency (RF) signal with a first local oscillation (LO) signal to generate a first intermediate frequency (IF) signal;
mixing said first IF signal with a second LO signal to generate a second IF signal; and
commutating said first and second LO signals between in-phase and quadrature phases.

18. The method of claim 17 wherein said commutating step comprises:
generating two complementary 50% duty cycle clock signals; and
commutating said first and second LO signals between in-phase and quadrature phases in accordance with said clock signals.

19. The method of claim 18 wherein said clock signals are waveforms selected from the group consisting of square waves and pseudo-random digital signals.

20. The method of claim 18 further comprising modulating said second IF signal by the difference between said clock signals.
